(19) United States
(12) Patent Application Publication
(10) Pub. No.: US 2021/0370721 A1
(43) Pub. Date: Dec. 2, 2021

(54) PNEUMATIC TIRE

(71) Applicant: Toyo Tire Corporation, Itami-shi (JP)

(72) Inventor: Tatsuhiro Nishino, Itami-shi (JP)

(73) Assignee: Toyo Tire Corporation, Itami-shi (JP)

(21) Appl. No.: 17/233,747

(22) Filed: Apr. 19, 2021

(30) Foreign Application Priority Data
May 26, 2020 (JP) 2020-091653

(51) Int. Cl. B60C 9/00; B60C 9/20

(52) U.S. Cl. CPC B60C 9/0042; B60C 2009/2019; B60C 2009/0092; B60C 9/20

(57) ABSTRACT

In a pneumatic tire according to an embodiment, a belt layer is configured such that the angle of a belt cord relative to the tire circumferential direction is more than 30° and 40° or less. An organic fiber cord of a belt-reinforcing layer, which is placed on the radially outer side of the belt layer, is configured such that when the number of twists per 10 cm length is T (twists/10 cm), the fineness is D (dtex), and the fiber density is ρ (g/cm³), the twist coefficient K defined as T×(D/ρ)^{1/2} is 900 to 2,600, and the product of the load at 5% elongation LASE 5% (N) of the organic fiber cord and the end count E (cords/25 mm) of the organic fiber cord is 1,000 N or more.

### CROSS-REFERENCE TO RELATED APPLICATIONS

This application is based upon and claims the benefit of priority from the prior Japanese Patent Application No. 2020-91653, filed on May 26, 2020; the entire contents of which are incorporated herein by reference.

### BACKGROUND

### 1. Technical Field

The present invention relates to a pneumatic tire.

### 2. Description of Related Art

It has been known that for the purpose of improving the high-speed durability of a tire, a belt-reinforcing layer obtained by arranging an organic fiber cord, such as a nylon fiber cord, substantially parallel to the tire circumferential direction is provided on the radially outer side of a belt layer (see JP-A-2005-239069, JP-A-2005-75289, and JP-A-2003-237309).

### SUMMARY

Incidentally, a belt layer is obtained by arranging a belt cord, such as a steel cord, obliquely relative to the tire circumferential direction, and the angle of the belt cord relative to the tire circumferential direction is generally set at around 20°. When such an angle of the belt cord is set greater than usual, for example, at more than 30°, the braking performance on a wet road surface (wet braking performance) and the steering stability can be improved. However, with an increase in the belt cord angle, the rigidity of the belt layer in the tire circumferential direction decreases, whereby the footprint shape deteriorates, resulting in a problem in that the high-speed durability or ride comfort decreases.

According to some embodiments of the invention, in light of the above points, it is desirable to provide a pneumatic tire capable of improving high-speed durability and ride comfort while maintaining wet braking performance and steering stability caused by an increased angle of a belt cord.

A pneumatic tire according to an embodiment of the invention includes: a belt layer obtained by arranging a belt cord obliquely relative to the tire circumferential direction on the radially outer side of a carcass layer in a tread part; and a belt reinforcing layer obtained by arranging an organic fiber cord along the tire circumferential direction on the radially outer side of the belt layer. The belt layer is configured such that the angle of the belt cord relative to the tire circumferential direction is more than 30° and 40° or less. The organic fiber cord of the belt reinforcing layer is configured such that when the number of twists per 10 cm length is T (twists/10 cm), the fineness is D (dtex), and the fiber density is ρ (g/cm³), the twist coefficient K defined as T×(D/ρ)^{1/2} is 900 to 2,600. The product of the load at 5% elongation LASE 5% (N) of the organic fiber cord and the end count E (cords/25 mm) of the organic fiber cord is 1,000 N or more.

According to some embodiments of the invention, the angle of the belt cord is set at more than 30° and 40° or less, and the twist coefficient of the organic fiber cord of the belt-reinforcing layer and also the product of LASE 5% and end count thereof are set as above. As a result, high-speed durability and ride comfort can be improved while maintaining wet braking performance and steering stability.

### BRIEF DESCRIPTION OF THE DRAWING

FIG. 1 A half section of a pneumatic radial tire of an embodiment.

### DESCRIPTION OF THE PREFERRED EMBODIMENT

Hereinafter, an embodiment of the invention will be described in detail.

A pneumatic tire according to this embodiment is characterized in the configuration of a belt layer and the configuration of a belt-reinforcing layer disposed on the radially outer side of the belt layer.

The belt layer is formed of at least one belt ply obtained by arranging a belt cord obliquely relative to the tire circumferential direction on the radially outer side (i.e., outer side in the tire radial direction) of a carcass layer in a tread part.

The belt-reinforcing layer is formed of an organic fiber cord arranged along the tire circumferential direction on the radially outer side (i.e., outer side in the tire radial direction) of the belt layer. The organic fiber cord of the belt-reinforcing layer extends substantially parallel to the tire circumferential direction, that is, at an angle of approximately 0° (preferably at an angle of 5° or less relative to the tire circumferential direction), and the cord is arranged at predetermined intervals in the tire width direction. Such a belt-reinforcing layer may be a cap ply, which covers the entire width of the belt layer, or may also be an edge ply, which covers the belt edge.

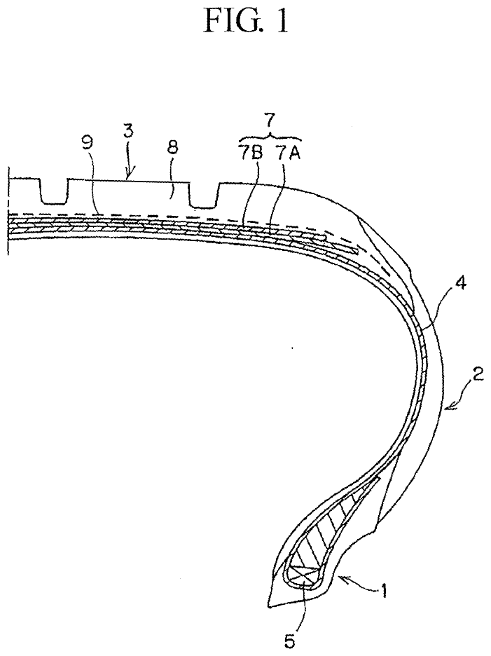

FIG. 1 is a half section of a pneumatic radial tire for passenger cars as an example of a pneumatic tire. The tire includes a pair of left and right bead parts (1), a pair of left and right side wall parts (2), and a tread part (3) provided between the two side wall parts (2), and a carcass layer (4) that extends toroidally is provided between the pair of bead parts (1).

The carcass layer (4) extends from the tread part (3) through the side wall part (2), and is, in the bead part (1), folded from inside to outside by a bead core (5) and thus locked. The carcass layer (4) is formed of at least one ply obtained by arranging a carcass cord made of an organic fiber substantially at a right angle relative to the tire circumferential direction.

On the radially outer side of the carcass layer (4) in the tread part (3), a belt layer (7) is placed. The belt layer (7) is provided over the outer circumference of the crown part of the carcass layer (4). The belt layer (7) can be composed of a single or plurality of belt plies, and is, in this example, composed of two plies, that is, a first belt ply (7A) on the inside and a second belt ply (7B) on the outside. Such a belt ply is formed of a belt cord, such as a steel cord, covered with a rubber, and is obtained by arranging the belt cord obliquely at a certain angle relative to the tire circumferential direction and at predetermined intervals in the tire width direction. The two belt plies (7A) and (7B) are disposed such that the belt cords intersect each other (i.e.; such that they are oblique with respect to the tire circumferential direction in a bilaterally symmetrical manner).

On the radially outer side of the belt layer (7), a belt-reinforcing layer (9) is provided between the belt layer (7) and a tread rubber (8). The belt-reinforcing layer (9) is, in this example, a cap ply that covers the full width of the belt layer (7). The belt-reinforcing layer (9) is formed of an organic fiber cord arranged substantially parallel to the tire circumferential direction, the organic fiber cord being covered with a rubber. The belt-reinforcing layer (9) secures the belt layer (7) in the circumferential direction, causing a pooping effect that enhances the rigidity in the tire circumferential direction and radial direction and also the belt binding force. Accordingly, the belt-reinforcing layer (9) suppresses the rise or diameter growth of the belt or the distortion of the belt edge caused by the centrifugal force during high-speed running, resulting in excellent high-speed durability performance and steering stability.

In this embodiment, in the belt layer, the angle of the belt cord relative to the tire circumferential direction (hereinafter sometimes simply referred to as “belt angle”) is set at more than 30° and 40° or less (i.e., 30°<belt angle ≤40°). That is, in the case where the belt layer is formed of a single belt ply, the belt angle of the single belt ply is set at more than 30° and 40° or less. In the case where the layer is formed of a plurality of belt plies, the belt angles of the belt plies, which are placed such that the belt cords intersect one another, are each set at more than 30° and 40° or less relative to the tire circumferential direction. When the belt angle is set at more than 30°, the wet braking performance and steering stability can be improved. When the belt angle is at 40° or less, a decrease in rigidity in the tire circumferential direction can be suppressed, and a decrease in high-speed durability can be suppressed. The belt angle is more preferably 31° or more and 37° or less, and still more preferably 32° or more and 35° or less.

With respect to the organic fiber cord used for the belt-reinforcing layer of this embodiment, the kind of organic fiber and the twist structure of the cord are not particularly limited. Various organic fibers, such as a nylon fiber, an aramid fiber, a polyester fiber, and a rayon fiber, can be used, and various twist structures, such as double-twisting and single-twisting, can be employed. It is preferable that at least one yarn constituting the organic fiber cord is made of a nylon fiber. For example, a nylon fiber cord obtained by twisting a plurality of nylon yarns together and a hybrid cord obtained by twisting a nylon yarn and another organic fiber yarn together can be mentioned. As a hybrid cord, a cord obtained by twisting a nylon yarn and an aramid yarn together is preferably used. More preferably, a nylon fiber cord having a double-twist structure obtained by twisting two nylon yarns together and a hybrid cord obtained by twisting one nylon yarn and one aramid yarn together can be mentioned.

Here, as nylon fibers, Nylon 6, Nylon 66, Nylon 46, and the like can be mentioned, for example. The aramid fiber may be para-type or meta-type, and known aramid fibers can be used.

As the organic fiber cord of the belt-reinforcing layer, one having a twist coefficient K of 900 to 2,600 is used. When the twist coefficient K is 900 or more, the deterioration of the fatigue resistance of the organic fiber cord can be suppressed, and the high-speed durability can be improved. In addition, when the twist coefficient K is 2,600 or less, an increase in the end count of the organic fiber cord necessary for obtaining a desired circumferential securing force can be suppressed. Accordingly, tire failures such as separation due to the end count being too high are suppressed, and the high-speed durability can be improved.

Here, the twist coefficient K is defined as T×(D/ρ)^{1/2}, wherein the number of twists per 10 cm length of the organic fiber cord is T (twists/10 cm), the fineness is D (dtex), and the fiber density is ρ (g/cm³). For example, in the case where a plurality of yarns (first-twisted yarns) are aligned and twisted together as in a double-twist structure, the number of twists T is the number of twists at the time of twisting such yarns together (the number of finish twists). The fineness D of an organic fiber cord is also referred to as nominal fineness. The fiber density ρ is the density of a fiber constituting the organic fiber cord. In the case of a cord composed of a single fiber, ρ is the density of such a fiber, while in the case of a hybrid cord, ρ is the average density calculated corresponding to the mass ratio of the fibers constituting the cord.

In one embodiment, in the case where the organic fiber cord of the belt-reinforcing layer is a nylon fiber cord obtained by twisting a plurality of nylon yarns together, the twist coefficient K is preferably 1,100 to 2,600. Specifically, it is preferable that a plurality of nylon yarns (first-twisted yarns) each obtained by twisting a bundle of nylon filaments in the Z-direction are aligned, and they are twisted together to a twist coefficient K of 1,100 to 2,600 in the direction opposite to the first-twisting direction, that is, in the S-direction. The twist coefficient K in this case is more preferably 1,300 to 2,600.

In one embodiment, in the case where the organic fiber cord of the belt-reinforcing layer is a hybrid cord obtained by twisting a nylon yarn and an aramid yarn together, the twist coefficient K is preferably 900 to 2,300. Specifically, it is preferable that a nylon yarn and an aramid yarn obtained by twisting a bundle of nylon filaments and a bundle of aramid filaments in the Z-direction, respectively, are aligned, and these first-twisted yarns are twisted together to a twist coefficient K of 900 to 2,300 in the direction opposite to the first-twisting direction, that is, in the S-direction. The twist coefficient K in this case is more preferably 1,300 to 2,100.

The fineness D of the organic fiber cord is not particularly limited, and may be 1,000 to 4,000 dtex, 1,500 to 3,500 dtex, or 1,800 to 3,000 dtex, for example. The number of twists T is not particularly limited either, and may be 20 to 60/10 cm or 25 to 55/10 cm, for example. Incidentally, in the case of a double-twist structure, the number of first twists may be set at the same value as the number of finish twists.

In the belt-reinforcing layer in this embodiment, the product of the load at 5% elongation LASE 5% (N) of the organic fiber cord and the end count E (cords/25 mm) of the organic fiber cord (i.e., LASE 5%×E) is set at 1,000 N or more. When the product of LASE 5% and end count E is 1,000 N or more, the belt binding force can be enhanced to improve the high-speed durability. The product of LASE 5% and end count E is preferably 1,100 N or more, and more preferably 1, 200 N or more. The upper limit is not particularly limited, and may be 3,000 N or less or 2,500 N or less.

The LASE 5% of the organic fiber cord is not particularly limited, and may be 30 to 100 N, 35 to 90 N, or 40 to 80 N, for example. The adjustments of the value of LASE 5% can be performed, for example, by selecting the kind of fiber constituting the organic fiber cord or by adjusting the cord structure, the number of twists, the cord treatment conditions, and the like. For example, by reducing the number of twists, LASE 5% can be increased. In addition, as the cord treatment conditions, conditions for a dip treatment in which the organic fiber cord is immersed in a resin liquid for an adhesion treatment with a rubber (resin liquid composition, treatment temperature, tension, time, etc.) can be mentioned, and the physical properties of the organic fiber cord can thus be adjusted. For example, in the case of performing the dip treatment using a resin liquid, such as resorcin-formalin-latex (RFL) or an aqueous blocked isocyanate solution, when a low-temperature bath is used, and the tension applied to the organic fiber cord is set high, LASE 5% can be increased. Here, LASE 5% is measured in accordance with JIS L1017.

The end count E of the organic fiber cord (the number of cords per 25 mm width of the belt-reinforcing layer) is not particularly limited. Depending on the value of LASE 5%, the end count E can be suitably set such that the product of the two satisfies the above range, and may be 15 to 50/25 mm, 20 to 40/25 mm, or 25 to 35/25 mm, for example.

Using the organic fiber cord described above, a green tire (unvulcanized tire) is prepared with the belt-reinforcing layer being wound on the radially outer side of the belt layer, and the obtained green tire is vulcanization-molded, whereby a pneumatic tire is obtained. In the formation of the belt-reinforcing layer on the belt layer, it is possible that the above organic fiber cord or a plurality of such cords aligned are covered with a rubber and wound spirally over the belt layer of the green tire, or a wide rubberized sheet formed of aligned organic fiber cords is wound once over the belt layer. The former, that is, spiral winding, is preferable.

### Examples

Hereinafter, the invention will be described in further detail through examples. However, the invention is not limited thereto.

### [Measurement Methods/Test Methods]

The measurement methods and test methods in the Examples are as follows.

### (Cord Test Methods)

Cord Diameter: One organic fiber cord was folded so as not to cause untwisting and made into four cords, aligned without sagging, and arranged in parallel. On such cords, using a predetermined dial gage (foot (gauge head) diameter: 9.5±0.03 mm, load: 1,666±29.4 mN), the foot was dropped from a height of about 6.5 mm to perform measurement.
Cord Strength: In accordance with JIS L1017, an organic fiber cord was allowed to stand under constant thermostatic conditions of 20° C. and 65% RH for 24 hours and then subjected to a tensile test at 20° C., and the load at break of the sample was determined.
LASE 5%: In accordance with JIS L1017, an organic fiber cord was allowed to stand under constant thermostatic conditions of 20° C. and 65% RH for 24 hours and then subjected to a tensile test at 20° C., and the load at 5% elongation was determined.

### (Tire Test Methods)

Belt Angle: With respect to an air-unfilled tire, the angle of the belt cord relative to the tire circumferential direction on the tire equator in the tread part (center position in the width direction) was measured.
Tire High-speed Durability: In accordance with FMVSS109 (UTQG). A drum tester 1,700 mm in diameter with a smooth surface made of steel was used. The tire internal pressure was set at 220 kPa, and the load was set at 88%, which is the maximum load specified in JATMA. After break-in at 80 km/h for 60 minutes, the tire was allowed to cool, and the air pressure was re-adjusted, followed by main running. The main running was started from 120 km/h. The speed was increased stepwise by 8 km/h every 30 minutes, and the tire was run until a failure occurred. The running distance until a failure occurred was expressed as an index relative to the tire of Comparative Example 1 as 100. A higher number indicates better high-speed durability.
Actual Car Steering Stability: Test tires incorporated with an internal pressure of 260 kPa were mounted on a test vehicle of 2,000 cc displacement, and the vehicle was driven on a test course by three trained test drivers and subjected to sensory evaluation. The rating was on a scale of 0 to 10, and relative comparison was made with the tire of Comparative Example 1 being rated as 6. The average score of the three was expressed as an index relative to the tire of Comparative Example 1 as 100. A higher number indicates better steering stability.
Ride Comfort: Each tire was adjusted to an internal pressure of 260 kPa using the standard rim specified in JIS, and four tires of the same kind were mounted on a 2,000-cc domestic passenger car. On a test course including a good road and a bad road, the ride comfort was sensorily evaluated by three test drivers and evaluated based on Comparative Example 1. Comfort equal to Comparative Example 1 was rated as “Fair”, inferior as “Poor”, and superior as “Good”.
Wet Braking Performance: Test tires incorporated with an internal pressure of 260 kPa were mounted on a test vehicle of 2,000 cc displacement, and the depth of water on the road surface was set at 1 mm. At a speed of 100 km/h, the brake pedal was stepped on, and the distance when the vehicle stopped was measured and expressed as an index relative to the tire of Comparative Example 1 as 100. A higher number indicates better wet braking performance.

### Examples/Comparative Examples

A pneumatic radial tire for passenger cars, having a tire size of 255/35ZR20 97Y and including a belt-reinforcing layer (9) as shown in FIG. 1, was prototyped. The belt angle of the belt layer and the configuration of the organic fiber cord constituting the belt-reinforcing layer (cap ply) were as shown in Table 1 below for each of the tires of the examples and comparative examples, and other configurations were common through all the tires.

Specifically, as the belt layer, a 2+2×0.25 mm steel cord was disposed with an end count of 23/25.4 mm, and two such plies were installed (the belt angle was as shown in Table 1).

With respect to the belt-reinforcing layer, in all the tires of the examples and comparative examples, the number of plies was 1.

With respect to the organic fiber cord constituting the belt-reinforcing layer, “Ny66” in Cord Material in Table 1 represents a Nylon 66 fiber, and “Aramid/Ny66” represents a hybrid cord of a para-aramid fiber and a Nylon 66 fiber. With respect to the cord structure, “1,400 dtex/2” means a double-twist structure obtained by twisting two first-twisted yarns having a nominal fineness of 1,400 dtex together. “1, 100 dtex/1+940 dtex/1” means a double-twist structure obtained by twisting a first-twisted yarn made of an aramid fiber having a nominal fineness of 1,100 dtex and a first-twisted yarn made of a nylon fiber having a nominal fineness of 940 dtex together.

The number of twists T in Table 1 means the number of finish twists. Incidentally, in all the cords, the number of first twists was set at the same number as the number of twists T in Table 1 (the number of finish twists). The fiber density ρ in the calculation of the twist coefficient K was set at p=1.14 g/cm³ for the nylon fiber cord, and at p=1.29 g/cm³ for the hybrid cord of a nylon fiber and an aramid fiber.

The nylon fiber cord of Comparative Example 1 and the nylon fiber cords of Examples 1, 3, and 5 and Comparative Examples 2, 3, and 6 are different not only in the number of twists T but also in the cord treatment conditions. With respect to the drying step, the heat-setting step, and the normalization step after dipping in a dip treatment using an RFL treatment liquid, in Comparative Example 1, the dying step was performed at a temperature of 140° C. with a tension of 1.14 N/cord, the heat-setting step at a temperature of 230° C. with a tension of 2.10 N/cord, and the normalization step at a temperature of 180° C. with a tension of 0.85N/cord. Meanwhile, in Examples 1, 3, and 5, and Comparative Examples 2, 3, and 6, the dying step was performed at a temperature of 170° C. with a tension of 1.70 N/cord, the heat-setting step at a temperature of 235° C. with a tension of 2.30 N/cord, and the normalization step at a temperature of 150° C. with a tension of 2.5 N/cord; by setting such conditions, LASE 5% was adjusted and increased.

The nylon fiber cord of Comparative Example 7 was different from the nylon fiber cord of Comparative Example 2 in that the tension in the normalization step in the dip treatment using an RFL treatment liquid was changed. That is, the tension was set at 1.5 N/cord.

Using each obtained tire, the tire high-speed durability, actual car steering stability, ride comfort, and wet braking performance were evaluated. Incidentally, tires with poor results in the tire high-speed durability test were not subjected to the actual car test. The results are shown in Table 1.

TABLE 1

| | Compar- | | | | | |
|---|---|---|---|---|---|---|
| | ative | | | | | |
| | Exam- | | | | | |
| | ple 1 | Example 1 | Example 2 | Example 3 | Example 4 | Example 5 |
| Cord Material | Ny66 | Ny66 | Aramid/Ny66 | Ny66 | Aramid/Ny66 | Ny66 |
| Cord Structure | 1400 | 1400 | 1100dtex/1 | 1400 | 1100dtex/1 | 1400 |
| | dtex/2 | dtex/2 | +940dtex/1 | dtex/2 | +940dtex/1 | dtex/2 |
| Cord Fineness (dtex) | 2800 | 2800 | 2040 | 2800 | 2040 | 2800 |
| Number of Twists T | 38 | 27 | 36 | 27 | 52 | 51 |
| (twists/10 cm) | | | | | | |
| Twist Coefficient K | 1883 | 1338 | 1432 | 1338 | 2068 | 2528 |
| Cord Diameter (mm) | 0.67 | 0.60 | 0.55 | 0.60 | 0.59 | 0.64 |
| Cord Strength (N) | 220 | 237 | 216 | 237 | 180 | 213 |
| LASE5% (N) | 30.0 | 48.0 | 73.0 | 48.0 | 67.0 | 37.0 |
| LASE 5% × E (N) | 840 | 1248 | 2044 | 1200 | 2278 | 1073 |
| End Count E | 28 | 26 | 28 | 25 | 34 | 29 |
| (cords/25 mm) | | | | | | |
| Belt Angle (°) | 33 | 33 | 33 | 38 | 33 | 33 |
| Tire Evaluation | | | | | | |
| Tire High-Speed | 100 | 105 | 108 | 102 | 109 | 103 |
| Durability | | | | | | |
| Actual Car Steering | 100 | 100 | 100 | 100 | 100 | 100 |
| Stability | | | | | | |
| Ride Comfort | Fair | Good | Good | Good | Good | Good |
| Wet Braking | 100 | 100 | 100 | 101 | 100 | 100 |
| Performance | | | | | | |

| | Compar- | Compar- | Compar- | Compar- | Compar- | Compar- |
|---|---|---|---|---|---|---|
| | ative | ative | ative | ative | ative | ative |
| | Exam- | Exam- | Exam- | Exam- | Exam- | Exam- |
| | ple 2 | ple 3 | ple 4 | ple 5 | ple 6 | ple 7 |
| Cord Material | Ny66 | Ny66 | Aramid/Ny66 | Aramid/Ny66 | Ny66 | Ny66 |
| Cord Structure | 1400 | 1400 | 1100dtex/1 | 1100dtex/1 | 1400 | 1400 |
| | dtex/2 | dtex/2 | +940dtex/1 | +940dtex/1 | dtex/2 | dtex/2 |
| Cord Fineness (dtex) | 2800 | 2800 | 2040 | 2040 | 2800 | 2800 |
| Number of Twists T | 58 | 18 | 22 | 66 | 27 | 58 |
| (twists/10 cm) | | | | | | |
| Twist Coefficient K | 2874 | 892 | 875 | 2625 | 1338 | 2874 |
| Cord Diameter (mm) | 0.65 | 0.58 | 0.53 | 0.62 | 0.60 | 0.65 |
| Cord Strength (N) | 205 | 238 | 230 | 148 | 237 | 210 |
| LASE5% (N) | 34.0 | 52.0 | 83.0 | 57.0 | 48.0 | 32.0 |
| LASE 5% × E (N) | 1020 | 1352 | 2158 | 2280 | 1248 | 960 |
| End Count E | 30 | 26 | 26 | 40 | 26 | 30 |
| (cords/25 mm) | | | | | | |
| Belt Angle (°) | 33 | 33 | 33 | 33 | 41 | 33 |
| Tire Evaluation | | | | | | |
| Tire High-Speed | 98 | 83 | 85 | 98 | 98 | 98 |
| Durability | | | | | | |
| Actual Car Steering | 100 | — | — | 100 | 94 | 100 |
| Stability | | | | | | |
| Ride Comfort | Good | — | — | Good | Fair | Good |
| Wet Braking | 100 | — | — | 100 | 99 | 100 |
| Performance | | | | | | |

As shown in Table 1, in Examples 1 to 5, as compared with Comparative Example 1, the tire high-speed durability and ride comfort were improved while maintaining the actual car steering stability and wet braking performance caused by an increased angle of the belt cord.

In contrast, in Comparative Example 2 where a nylon fiber cord having a twist coefficient K of 2,874, which is outside the prescribed range, was employed, the end count increased in order to obtain a desired securing force. Accordingly, the cut end part of the belt-reinforcing layer was susceptible to adhesive failures, and the tire high-speed durability did not improve. In Comparative Example 3 where a nylon fiber cord having a twist coefficient K of 892, which is outside the prescribed range, was employed, the fatigue resistance of the cord was poor, and the tire high-speed durability significantly deteriorated as compared with Comparative Example 1. In Comparative Example 4 where a hybrid cord of aramid and nylon having a twist coefficient K of 875, which is outside the prescribed range, was employed, the fatigue resistance of the cord was poor, and the tire high-speed durability significantly deteriorated as compared with Comparative Example 1. In Comparative Example 5 where a hybrid cord of aramid and nylon having a twist coefficient K of 2,625, which is outside the prescribed range, was employed, the end count increased in order to obtain a desired securing force. Accordingly, the cut end part of the belt-reinforcing layer was susceptible to adhesive failures, and the tire high-speed durability did not improve. In Comparative Example 6 where the belt angle was 41°, which is outside the prescribed range, the binding force in the tire circumferential direction decreased, and the tire high-speed durability did not improve. In addition, the actual car steering stability decreased, and an improving effect on the ride comfort was not seen either. In Comparative Example 7 where the product of LASE 5% and end count E was less than 1,000 N, the binding force decreased, and the tire high-speed durability did not improve.

Some embodiments of the invention have been described above. However, these embodiments are presented as examples and not intended to limit the scope of the invention. These embodiments can be practiced in other various modes, and, without departing from the gist of the invention, various omissions, substitutions, and changes can be made thereto. These embodiments, as well as omissions, substitutions, and changes thereto, for example, fall within the scope and gist of the invention, and also fall within the scope of the claimed invention and its equivalents.

Embodiments of the invention can be suitably used for various pneumatic tires including passenger car tires.

What is claimed is:

1. A pneumatic tire comprising:
a belt layer obtained by arranging a belt cord obliquely relative to a tire circumferential direction on the radially outer side of a carcass layer in a tread part; and
a belt-reinforcing layer obtained by arranging an organic fiber cord along the tire circumferential direction on the radially outer side of the belt layer,
the belt layer being configured such that an angle of the belt cord relative to the tire circumferential direction is more than 30° and 40° or less,
the organic fiber cord of the belt-reinforcing layer being configured such that when a number of twists per 10 cm length is T (twists/10 cm), a fineness is D (dtex), and a fiber density is ρ (g/cm³), a twist coefficient K defined as T×(D/ρ)^{1/2} is 900 to 2,600, and the product of a load at 5% elongation LASE 5% (N) of the organic fiber cord and an end count E (cords/25 mm) of the organic fiber cord is 1,000 N or more.

2. The pneumatic tire according to claim 1, wherein the organic fiber cord of the belt-reinforcing layer is an organic fiber cord obtained by twisting a plurality of nylon yarns together, and the twist coefficient K is 1,100 to 2,600.

3. The pneumatic tire according to claim 1, wherein the organic fiber cord of the belt-reinforcing layer is a hybrid cord obtained by twisting a nylon yarn and an aramid yarn together, and the twist coefficient K is 900 to 2,300.

4. The pneumatic tire according to claim 1, wherein in the belt layer, the angle of the belt cord relative to the tire circumferential direction is 31° or more and 37° or less.

5. The pneumatic tire according to claim 1, wherein the fineness D of the organic fiber cord of the belt-reinforcing layer is 1,000 to 4,000 dtex.

6. The pneumatic tire according to claim 1, wherein the number of twists T of the organic fiber cord of the belt-reinforcing layer is 20/10 cm to 60/10 cm.

7. The pneumatic tire according to claim 1, wherein the LASE 5% of the organic fiber cord of the belt-reinforcing layer is 30 to 100 N.

8. The pneumatic tire according to claim 1, wherein the end count E of the organic fiber cord of the belt-reinforcing layer is 15/25 mm to 50/25 mm.
